(19) United States
(12) Patent Application Publication
(10) Pub. No.: US 2015/0167551 A1
(43) Pub. Date: Jun. 18, 2015

(54) GAS TURBINE PROCESS WITH UPDRAFT POWER PLANT

(71) Applicant: Siemens aktiengesellschaft, Munich (DE)

(72) Inventors: Uwe Lenk, Zwickau (DE); Alexander Tremel, Erlangen (DE)

(73) Assignee: Siemens aktiengesellschaft, Munich (DE)

(21) Appl. No.: 14/407,164

(22) PCT Filed: May 6, 2013
(86) PCT No.: PCT/EP2013/059359

§ 371 Date: Dec. 11, 2014

(30) Foreign Application Priority Data
Jun. 14, 2012 (DE) 12171899.3

(51) Int. Cl. F02C 6/18; F01D 15/10

(52) U.S. Cl. CPC F02C 6/18; F01D 15/10

(57) ABSTRACT

A power plant having at least one gas turbine and at least one tower that is equipped with a power generation unit and is used for generating electricity from an aerodynamic updraft in the tower is provided herein. The gas turbine is fluidically coupled to the tower in such a way that at least some of the exhaust gas from the gas turbine can flow through the tower during operation, the gas turbine being fluidically coupled to the tower at least in part by a duct that has a duct section via which fresh air can be fed to the exhaust gas so as to mix therewith before and/or while the mixture is conducted into the tower.

### CROSS REFERENCE TO RELATED APPLICATIONS

This application is the US National Stage of International Application No. PCT/EP2013/059359 filed May 6, 2013, and claims the benefit thereof. The International application claims the benefit of European Application No. EP12171899 filed Jun. 14, 2012. All of the applications are incorporated by reference herein in their entirety.

### FIELD OF INVENTION

The present invention relates to a power plant comprising at least one gas turbine and also at least one tower, provided with a power generating unit, for generating electric power by means of air-dynamic updraft in the tower, as well as a method for operating such a power plant.

### BACKGROUND OF INVENTION

For increasing the process efficiency of a gas turbine which is provided for power generation, this is typically operated with a coupled steam turbine cycle in the sense of a gas- and steam turbine process (CCPP process). In this case, the provision of water is required not only for the support of the water-steam cycle which is accommodated by such a plant, but also the cooling devices which interact therewith possibly need the provision of cooling water. Although the water-steam cycle in principle constitutes a closed system, water losses still have to be continuously compensated (“make-up” water requirement) during practical operation. This leads to a continuous water requirement of 1 to 2% of the overall steam quantity or 60 to 70 kg per generated megawatt-hour.

The operation of gas turbines for power generation in conjunction with a steam turbine cycle, however, represents a huge challenge in very dry regions, e.g. in desert regions. Rather, in such regions a general water supply can be ensured only with high costs so that a demand for larger quantities of water for industrial use frequently cannot be economically satisfied due to the local infrastructure. Especially when large quantities of water are required, for example for cooling by means of cooling devices which are supplied with water, is the local water infrastructure normally incapable of meeting these demands. Therefore, the object set upon specifying a combined gas turbine process which is capable of avoiding the disadvantages which are known from the prior art. Especially desired is a combined gas turbine process which also enables an operation in very dry regions of the world. This is to enable an operation with relatively low demands for the provision of water. Also desired would be an efficient power plant solution which makes use of a combined gas turbine process which does not require a water-steam cycle.

Solutions for this are already known from the prior art. Thus, WO 03/025395A1, for example, describes an updraft power plant, the operation of which provides for the air masses which rise in the updraft power plant to be thermally conditioned by means of a burner operation. The burners can also be replaced by a gas turbine, according to the embodiment. During operation of the updraft power plant, the exhaust gases of the gas turbine are fed to the updraft power plant by means of an underground feed duct and introduced into a predefined flow duct.

The principle of power generation by means of driving a generator by means of air masses, which are thermally conditioned by exhaust gases, in a defined flow duct is also described in DE 10 2007 045 297 A1 or in US 2010/0270807 A1.

A disadvantage of the solutions known from the prior art, however, is that with the introduction of exhaust gases of a gas turbine into an updraft power plant there is the fear of material damage to the structure to the flow duct and/or to other functional components of the power plant. Since the exhaust gas temperature of a gas turbine can achieve a temperature level of between 500° C. and 600° C. after emission, thermal damage is to be feared especially in the case of such components which cannot adequately withstand these high temperatures.

### SUMMARY OF INVENTION

In this respect, the object upon which embodiments of the invention are based is set upon proposing a power plant in which these disadvantages from the prior art are avoided. In particular, the power plant, which has at least one gas turbine and also at least one tower provided with a power generating unit, is to avoid material fatigue of structural and functional components due to thermal interaction with hot exhaust gas from the gas turbine.

These objects upon which embodiments of the invention are based are achieved via a power plant and also via a method for operating such a power plant according to the claims.

In particular, these objects upon which embodiments of the invention is based are achieved by means of a power plant which comprises at least one gas turbine and also at least one tower, provided with a power generating unit, for generating electric power by means of an air-dynamic updraft into the tower, wherein the gas turbine is fluidically coupled to the tower in such a way that during operation at least some of the exhaust gas of the gas turbine can flow through the tower, wherein the gas turbine is fluidically coupled to the tower at least partially by means of a flow duct, and wherein the flow duct has a flow section via which fresh air can be added to the exhaust gas so that it mixes with the exhaust gas before and/or while the mixture is fed to the tower.

Furthermore, the objects upon which embodiments of the invention are based are achieved by means of a method for operating a power plant which comprises at least one gas turbine and also at least one tower, provided with a power generating unit, for generating electric power by means of an air-dynamic updraft in the tower, wherein during operation of the gas turbine exhaust gas is fed to the tower in such a way that at least some of the exhaust gas flows through the tower and can generate electric power by means of the power generating unit, wherein fresh air is added to the exhaust gas before it is fed to the tower.

At this point, reference may be made to the fact that the term gas turbine is to be understood in its broadest sense. In particular, gas turbines which are operated with hydrogen as fuel are also included in this case.

According to the embodiment, the power generating units which are accommodated by the least one tower are typically designed as turbine-driven generators. Other power generating units are also conceivable, however.

A tower, provided with a power generating unit, for generating electric power by means of an air-dynamic updraft in the tower is also to be referred to below as an updraft power plant.

On account of the fluid-dynamic coupling of a gas turbine to the tower, it is possible in the main to dispense with the use of water. In particular, the use of cooling water or water in a water-steam cycle can be dispensed with in this way. The coupling of gas turbine and updraft power plant is carried out purely air-dynamically. As a result, the designated power plant is especially also suitable for operation in very dry regions of the world.

Furthermore, the invention allows the widening of the load window of a gas turbine which is operated between a lower range of the minimum load requirement and an upper range of the maximum power limit. On account of the additional and—as is explained further below—also partially independent generation of electric power by means of the updraft power plant, the upper range of the maximum power limit can be additionally extended, as a result of which a higher overall electric power output of the combined power plant is made possible. Also, during sole operation of the updraft power plant the load window can also be additionally lowered down to smaller power outputs. As a result, the load window is therefore widened in comparison to a simple-cycle gas turbine power plant on the one hand, and on the other hand the flexibility of the operation is noticeably increased.

Furthermore, on account of the combination of gas turbine process and air-dynamically coupled updraft power plant, the demand for station electrical services can also be covered at times outside the power operation of the gas turbine, that is to say, for example, during startup, cooling down or during standby, by means of the electric power which the power generating unit of the updraft power plant can provide. This is especially the case when the heat of the exhaust gas of the gas turbine is thermally temporarily stored.

According to the invention, the functionality and flexibility of a simple-cycle gas turbine power plant are therefore extended by means of the air-dynamically coupled updraft power plant. According to an opposite point of view, mention may also be made of the fact that an updraft power plant is functionally extended by an external power source. Therefore, particularly the hot exhaust gas, which during firing of the gas turbine discharges from this, serves for actively driving the convection processes which are running in the updraft power plant. According to this point of view, the convection process which is running in the tower of the updraft power plant is supported or even maintained by the thermal heat of the exhaust gas of the gas turbine. As a result, it is therefore also possible to operate the updraft power plant without the otherwise typical solar thermal collector surface. This solar thermal collector surface, which typically serves for the conversion of solar radiation into heat which in turn supports convective air flow processes, can consequently be replaced by a specific fluidic coupling between the gas turbine and the tower which is accommodated by the updraft power plant. By the same token, it is possible that a complete replacement of these thermal processes is not carried out but only a time-based support by means of the exhaust gases which are emitted from the gas turbine. Unlike as in the case of a conventional combined gas- and steam turbine process, in the present case a combined gas- and gas turbine process is therefore claimed.

In the case of the fluidic coupling of gas turbine and tower of the updraft power plant which is proposed according to the invention, attention is to be paid to the fact that exhaust gas emitted from the gas turbine during normal operating conditions has a very high temperature level of typically above 400° C. Consequently, it is normally necessary to thermally condition the exhaust gas, before it is introduced into the tower, to the extent that no material damage to the tower can occur. The thermal conditioning is carried out in this case by means of a suitable heat exchange process, or a mixing process, which can achieve the reduction of the overall temperature level of the exhaust gas or of the mixture with air.

At this point, it may be noted that within the scope of this invention no distinct conceptual difference is made between an operation of the updraft power plant with air, with exhaust gas or with a mixture of both.

According to the invention, it is provided that the gas turbine is fluidically coupled to the tower of the updraft power plant at least partially by means of a flow duct. The flow duct allows a specific and controlled fluidic coupling between the gas turbine and the tower of the updraft power plant. Consequently, for example a specific fluidic introduction of the exhaust gases of the gas turbine into the tower is possible.

According to an embodiment of the invention, it is furthermore provided that the flow duct has a flow section via which fresh air can be added to the exhaust gas so that it mixes with the exhaust gas before and/or while the mixture is fed to the tower. The flow section therefore ensures a mixing process between the exhaust gas and the fresh air from the environment which in comparison to the exhaust gas has a considerably lower temperature level. During the mixing process, the exhaust gas is consequently conditioned with regard to its temperature level to the extent that the overall gas mixture can achieve a temperature level which is suitable for introduction into the tower of the updraft power plant without having to fear material damage to the tower. In particular, the temperature level of the overall gas mixture is low enough for there to be no need to fear material damage as a result of thermal action upon the materials of the tower.

According to a first embodiment of the invention, the flow duct has a closable branch duct via which the exhaust gas can be fed to a flow path, which branch duct does not open into the tower but opens especially into the free environment. Consequently, during maintenance operations on the updraft power plant, for example, the exhaust gas from the gas turbine can be fed to another flow path without it being introduced into the tower of the updraft power plant. Moreover, it is also conceivable that the exhaust gas is fed via the other flow path to further thermal processes which are not in direct communication with the power generation in the updraft power plant. Thus, for example the exhaust gas can also be fed to thermal industrial processes as are customary in the crude oil processing industry, for instance.

According to a further preferred embodiment, it is provided that the flow duct comprises a shut-off device which fluidically closes off the flow duct, especially closes it off in such a way that no exhaust gas can be fed to the tower. This embodiment ensures a specific and controlled shut-off of the exhaust gas in order to save this from being fed into the tower of the updraft power plant. In particular, the shut-off device of the flow duct is connected by open loop control to a shut-off device of the closable branch duct.

According to a continuation of the invention, it is provided that the flow section is arranged at the end of the flow duct, especially beneath the tower on its base. The base is to be understood in this case as the foot region of the tower of the updraft power plant. In this case, the foot region can be of an open design, comparable to a cooling tower, or partially or completely encased.

According to a specific embodiment, the flow section can be formed as a mixing receptacle in which the exhaust gas can be mixed with the fresh air in a predetermined ratio and then flow out as an overall gas mixture via flow openings made in the mixing receptacle. Especially preferably, the flow duct also opens into the base of the tower, especially in such a way that the flow direction corresponds to the direction of longitudinal extension of the tower, and creates there a fluid-dynamic suction effect upon the air of the environment on account of the high flow velocities of the exhaust gas discharging from the flow duct. This, as fresh air, is mixed with the exhaust gas discharging from the flow duct and consequently flows through the tower together with the exhaust gas in the form of an overall gas mixture. In addition to the reduction of the overall temperature level, an increase of the overall mass flow, which is made available for electric power generation by means of the updraft power plant, is also achieved in this way.

Depending upon the developing temperature difference and overall mass flow, as well as upon the geometry of the tower, a suitable convective updraft can therefore be created in the tower, serving for power generation. According to a specific embodiment, a fresh air blower can also be completely dispensed with on account the mixing processes between exhaust gas and fresh air, as a result of which the overall efficiency of the combined power plant is once more increased. Similarly, such a blower can also be provided for supporting effect.

According to an especially preferred embodiment of the present invention, it is provided that the flow duct is fluidically coupled to a thermal heat accumulator in such a way that the exhaust gas, before it is fed to the tower, is in thermal contact with the heat accumulator. The thermal heat accumulator allows the temporary storage of thermal heat which is extracted from the exhaust gas so that this can be extracted from the heat accumulator again and utilized at a later point in time. The thermal heat accumulator consequently allows a functional expansion for a timewise flexible operation of the power plant. The heat accumulator according to the embodiment can be designed for storing latent heat and/or sensible heat. In this case, the heat accumulator can be designed, for example, as a concrete heat accumulator with air passages, as loose stones, as a fluidized bed or as a liquid saline mixture for storing sensible heat. Furthermore, the heat accumulator can be formed as a salt or a metal which during a phase change becomes molten (latent heat accumulator). Furthermore, the use of a reversible chemical reaction for heat storage is also possible. The heat accumulator can especially be designed so that the hot gas turbine gas is directed to a flow section of the flow duct without further temperature influencing in order to be mixed with fresh air there. If the thermal heat accumulator is full, i.e. it has fully attained the temperature level of the exhaust gas, the exhaust gas flows to this flow section without being thermally further conditioned.

If, during changing operating conditions of the gas turbine, the exhaust gas temperature is now reduced or the exhaust gas is no longer available because the gas turbine is not in operation, for instance, air can still be thermally treated by means of the heat accumulator in order to be subsequently introduced into the tower of the updraft power plant for power generation.

According to a modified embodiment of this idea, it is provided that the thermal heat accumulator is arranged beneath the tower on its base, especially arranged in such a way that thermal heat can be emitted directly to the environment of the base by means of the heat accumulator over a prespecified surface. According to the embodiment, the air which is present over the thermal accumulator can therefore, for example, be heated to the extent that this flows to the tower by means of thermal convection. On account of these convection processes, fresh air is drawn in from the environment, as a result of which a mixing process, which is carried out over the thermal heat accumulator, is maintained. Arranging the thermal heat accumulator in the region of the base of the tower can in turn result in the avoidance of additional fresh air blowers so that a particularly energy-efficient power plant can be made available. As a result of the spatial proximity provided according to the embodiment between tower and thermal heat accumulators, the thermal power losses can be largely minimized, moreover, as a result of which the thermal overall efficiency of the power plant can in turn be improved.

According to a preferred continuation of this embodiment, it is provided that the prespecified surface of the thermal heat accumulator covers at least 30%, especially at least 50%, of the projection of the inlet opening of the tower oriented perpendicularly to the ground. Consequently, the prespecified surface of the heat accumulator is distinguished by its size which can cover a proportion of the projection of the inlet opening of the tower. As a result, it is ensured that the heat emission by the thermal heat accumulator can be carried out over the surface, as a result of which the temperature level of the mixture of exhaust gas and air, or of thermally conditioned air, which flows into the tower is of sufficient value in order to support or to maintain the necessary convection processes in the tower for power generation. On account of the size of the surface, a good heat emission to the environment can be carried out and also an efficient operation of the updraft power plant can be ensured.

An efficient operation is also especially the case when after a period of operation of the gas turbine the thermal heat accumulator is charged and then, with the gas turbine shut down, heat is continuously emitted from the thermal heat accumulator to air of the environment. Accordingly, the power generating unit in the tower can in the main be operated continuously even when the gas turbine itself is no longer being operated.

According to a further embodiment of the invention, it is provided that the heat accumulator is suitable for storing thermal heat at a temperature level of at least 300° C., especially of at least 400° C. Consequently, the heat accumulator can temporarily store a comparatively large amount of heat which can also maintain the operation of the power generating unit in the updraft power plant over a time period of several hours outside of the operating periods of the gas turbine. As already explained above, thermal heat can be temporarily stored in a suitable manner at the temperature level according to the embodiment by means of a concrete block, salt or metal.

According to a further aspect of the present invention, it can be provided that a large number of outlet openings are featured by the heat accumulator, out of which the exhaust gas can flow for mixing with fresh air, especially flow out in a free manner. The large number of outlet openings ensure a specific mixing of the outflowing gas with fresh air so that suitable mixing can be carried out. A free outflowing corresponds in this case to an outflowing behavior which is not fluidically restricted in the flow direction, that is to say an outflowing which is not influenced by flow resistances. According to a continuation of this idea, the large number of outlet openings can also be arranged beneath the tower on its base. Consequently, a specific mixing of the exhaust gas with fresh air can already be achieved in the base region of the tower so that the overall gas mixture can enter the tower for power generation without a further mixing process being necessary.

According to the embodiment, it is also possible that the power plant does not have a flow generator which applies a flow to the fresh air which is provided for mixing with the exhaust gas. According to the embodiment, the fresh air flow for mixing with the exhaust gas is consequently created purely on account of secondary effects or, e.g. by differences in temperature or pressure. These can occur, for example, with a suitable flow behavior of the exhaust gas, as a result of which a mixing with fresh air can be carried out convectively as a result of fluidic pressure differences. According to the embodiment, the flow generator can consequently be dispensed with, as a result of which the overall efficiency of the power plant is improved.

According to a further embodiment of the invention, it is provided that the tower has a height level of at most 200 m, especially of at most 150 m. Admittedly, it is known that the power generated in an updraft power plant is significantly dependent upon the tower height, but according to the embodiment the constructional cost and the investment costs associated therewith have priority. Therefore, it is also possible, for example, to provide industrial chimneys of standard construction with a height of 100 to 150 m for the updraft power plant. With a tower height of 150 m in combination with a gas turbine which has a rated power of 200 MW, for example an electric power output of approximately 1.5 MW can therefore be achieved by means of the power generating unit of the updraft power plant. This amount of energy is particularly sufficient in order to design the timewise power output of the power plant more uniformly, as well as to ensure an electric power output for station service when the gas turbine is stationary.

According to a first preferred embodiment of the method according to the invention, it is provided that such a quantity of fresh air is added to the exhaust gas, before it is fed to the tower, that the temperature level of the mixture is at most 200° C., especially at most 120° C., when it flows to the tower. As a result of this temperature reduction of the overall mixture of exhaust gas and fresh air, it can be ensured that the material featured by the tower suffers no unexpected thermal damage. Furthermore, this temperature range is especially suitable for generating a sufficiently large convective flow in the tower of the updraft power plant which can be utilized for an efficient power generation by means of the power generating unit.

Individual embodiments of the invention shall be explained below with reference to figures. In this case, the substantiations in relation to the embodiments constitute no limitations at all with regard to the general inventive doctrine. Furthermore, the depicted figures are to be understood schematically, as a result of which no limitations at all can in turn be deduced from a possible substantiation.

### BRIEF DESCRIPTION OF THE DRAWINGS

In the drawing in this case:

FIG. 1 shows a first embodiment of the power plant according to the invention in a schematic view of connections;

FIG. 2 shows a further embodiment of the power plant according to the invention in a schematic view of connections;

FIG. 3 shows a further embodiment of the power plant according to the invention in a schematic view of connections;

FIG. 4 shows a diagram for representing the theoretical efficiency improvement of a gas turbine process coupled to an updraft power plant in comparison to an isolated simple-cycle gas turbine process in dependence upon the height of the tower of the updraft power plant;

FIG. 5 shows a diagram for representing the gas turbine temperature after the mixing of fresh air and exhaust gas for exhaust gas temperatures of 500° C. and 600° C. with different mixing ratios.

### DETAILED DESCRIPTION OF INVENTION

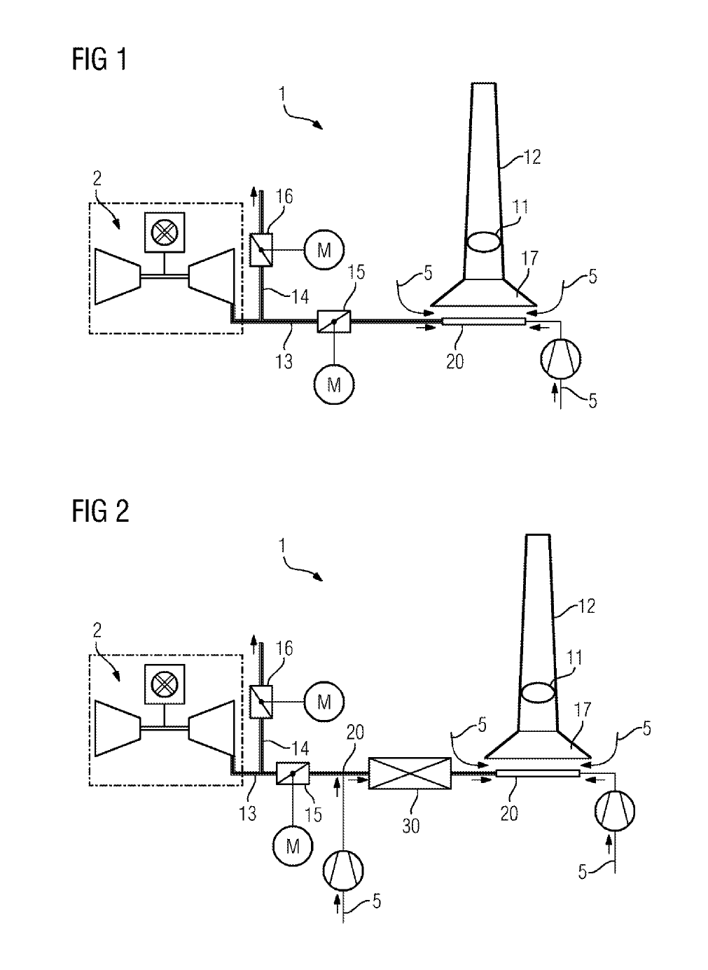

FIG. 1 shows a first embodiment of the power plant 1 according to the invention in a schematic view of connections. The power plant 1 comprises a gas turbine 2 which is fluidically coupled via a flow duct 13 to the tower 12 of an updraft power plant. The updraft power plant in its turn comprises a tower 12 which is provided with a power generating unit 11. The power generating unit 11 is typically designed as a generator which is driven via a turbine. In order to conduct the air flow in the region of the base of the tower 12 in a directed manner, the tower 12 has an inflow region 17 which has an inflow opening, oriented towards the ground, which is of a widened design in comparison to the opening which is oriented toward the tower 12. Arranged beneath the inflow region 17 is a flow section 20 which is designed for mixing the exhaust gas discharging from the gas turbine 2 with fresh air 5 originating from the environment. To this end, the flow section 20 is connected on one side to the flow duct 13 in such a way that the exhaust gas discharging from the gas turbine 2 flows into the flow section 20. At the same time, the flow section 20 is connected on another side to a fresh-air feed duct (not provided with a designation) via which fresh air 5 is supplied by means of a blower (not provided with a designation).

Furthermore, the flow duct 13 comprises a branch duct 14 which by means of a shut-off device 16 can be fluidically closed or opened. The shut-off device 16 can be actuated by a motor in the present case. Similarly, the flow duct 13 has a shut-off device 15 which can also be actuated by a motor. This shut-off device 15 also allows the flow duct 13 to be opened or closed.

During operation of the gas turbine 2, exhaust gas is produced during firing and is introduced into the flow duct 13. This process can be supported by means of a flow generator. Depending on the actuated state of the shut-off devices 15 and 16, the exhaust gas flows into the flow duct 13 and/or into the branch duct 14. If, for example, the branch duct 14 is closed by means of the shut-off device 16, but the flow duct 13 is open, the exhaust gas flows to the flow section 20. If at the same time the blower for providing fresh air 5 is operated by means of the fresh-air feed duct, fresh air 5 of a considerably lower temperature level than that of the exhaust gas is fed to the flow section 20 at the same time. In the flow section 20, a mixing of the exhaust gas with the fresh air 5 is consequently carried out. After mixing has been carried out, or during the mixing process, the thereby produced gas mixture, on account of its higher temperature level in comparison to the environment, rises upwards and is fed to the inflow region 17 of the tower 12. Due to the convective flow movement of the gas mixture, additional fresh air 5 is drawn into the inflow region 17 from the environment as well. In the inflow region 17, a continuing mixing of fresh air 5 and the mixture of exhaust gas and fresh air 5 discharging from the flow section 20 is therefore carried out. On account of the pressure difference between the base of the tower 12 and the tower peak, and also on account of the prevailing temperature difference of gas mixture flowing into the inflow region 17 and the air prevailing at the tower peak, a convective gas flow is formed in the tower 12 and drives the power generating unit 11—mechanically, for example—for power generation.

If in another operating state, however, the shut-off device 15 of the flow duct 13 is closed, no exhaust gas is fed to the tower 12 of the updraft power plant. Alternatively, in such a case, however, the exhaust gas can be discharged via the branch duct 14 if the shut-off device 16 is opened. For example, by means of the branch duct 14 the exhaust gas discharging from the gas turbine 2 can be fed to an industrial process for heat utilization.

FIG. 2 shows a further embodiment of the invention in a schematic view of connections which differs from the embodiment shown in FIG. 1 to the extent that a heat accumulator 30 is connected into the flow duct 13 downstream with regard to the shut-off device 15. Between the shut-off device 15 and the heat accumulator 30, provision is made, moreover, for a fresh-air feed duct which feeds fresh air 5 to the flow duct 13 by means of a flow generator (blower). According to the embodiment, the exhaust gas discharging from the gas turbine consequently flows through the heat accumulator 30 downstream of the shut-off device 15 in the flow duct 13 and transfers a proportion of its heat to this. This thermal energy is stored in the heat accumulator 30 and made available at a later point in time for further extraction. If the heat accumulator 30 is charged, heat from the heat accumulator 30 can also be transferred via fresh air 5 when the gas turbine 2 is stationary and in its turn is fed again to the flow section 20. To this end, fresh air 5 is fed to the flow duct 13 via the fresh-air feed duct which is arranged between the shut-off device 15 and the heat accumulator 30 and directed through the heat accumulator 30. During this feeding of fresh air, the shut-off device 15 can be closed so that no fresh air flows in the direction of the gas turbine 2. On its way to the flow section 20 through the heat accumulator 30, thermal heat is transferred to the fresh air 5, as a result of which this is heated. The temperature level of the thereby conditioned fresh air 5 typically roughly reaches the temperature level of the heat accumulator 30. Subsequently, a further mixing with fresh air 5 is carried out in turn in the flow section 20 and is fed from the additionally provided fresh-air feed duct to the flow section 20. It is also conceivable that during specific operating conditions no additional feeding of fresh air into the flow section 20 is carried out. The additional operating steps correspond to the embodiment shown in FIG. 1.

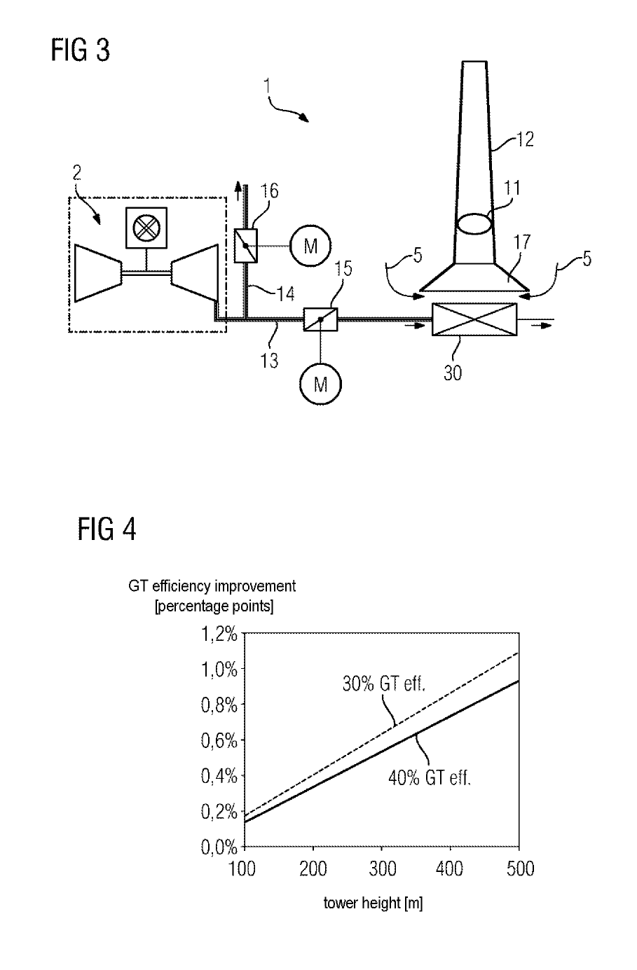

FIG. 3 shows a further embodiment of the invention in a schematic view of connections. In this case, the embodiment shown in FIG. 3 differs from the embodiment shown in FIG. 2 to the extent that the flow section 20 is replaced by the heat accumulator 30. Furthermore, the depicted embodiment comprises no fresh-air feed lines which would open into the flow duct 13 or into the flow section 20. Rather, the mixing of exhaust gas and fresh air is only carried out in the foot region between the heat accumulator and the inflow region 17 of the tower 12.

During operation of the gas turbine 2, exhaust gas can be fed to the heat accumulator 30 via the flow duct 13 with the shut-off device 15 open. The heat accumulator 30 can now be designed so that the exhaust gas heating it flows through and, via openings which are oriented towards the inflow region 17, at least partially flows out. By the same token, however, an embodiment is also conceivable in which the exhaust gas only charges the heat accumulator 30 without itself being transferred into the inflow region 17 of the tower 12, however. Rather, the exhaust gas, according to such an embodiment, is discharged through the heat accumulator 30 and is made available to further thermal engineering applications. The heat accumulator 30, however, is designed in such a way that it is able to emit thermal heat on its side oriented towards the tower 12 so that the air in thermal contact with this surface is thermally conditioned. This thermal conditioning leads to an increase of the temperature level of this air so that a convective ascending flow results. The air layers which are moved on account of this flow are fed to the inflow region 17, wherein at the same time fresh air 5 flows in the region of the base of the tower 12 and mixes with the thermally conditioned air. On account of the thermal conditioning, in turn a convective updraft results in the tower 12 which serves for electric power generation by means of the power generating unit 11.

According to the alternative embodiment, described above, of the heat accumulator 30, this can also have suitable openings so that via these at least some of the exhaust gas can discharge in order to be mixed with fresh air 5 in the region of the base of the tower 12 and be fed to the inflow region 17 of the tower 12. The additional process-engineering steps then correspond in turn to those of the embodiments according to FIG. 1 and FIG. 2.

FIG. 4 shows a graphic representation of the theoretical calculated dependency of the overall efficiency of a gas turbine process coupled to an updraft power plant in comparison to the isolated simple-cycle gas turbine process in dependence upon the tower height of the updraft power plant. In this case, two different straight lines are plotted, corresponding to different levels of electrical efficiency of the simple-cycle gas turbine power plant. The two levels of efficiency are 30% (dashed line) and 40% (continuous line). The calculations show that with increasing tower height the overall efficiency of the power plant 1 is progressively increased. If the efficiency improvement of the overall process with a tower height of 100 m is about 0.2%, then the efficiency improvement with a tower height of 500 m is between 0.9 and 1.1%.

The functional dependencies shown in FIG. 4 were calculated on the basis of the following laws of conformity. In this case, the following physical relationship for the tower efficiency of an updraft power plant was assumed:

$$η = \frac{g \cdot h}{{c}_{p} \cdot {T}_{0}}$$

g: force of gravity

h: tower height

cₚ: specific isobaric thermal capacity of air

T₀: ambient temperature.

The quantity of heat available can be calculated either from the exhaust gas flow of the turbine according to the following law of conformity,

Q=\dot{m}cₚ(T_{flue gas}−T₀)

\dot{m}: mass flow of the exhaust gas

T_{flue gas}: exhaust gas temperature of the gas turbine, or according to the electric power of the gas turbine and the electric gas turbine efficiency according to the following relationship:

$$Q = \frac{P}{{η}_{GT}} - P$$

P: gas turbine electric power

η_{GT}: gas turbine electric efficiency.

From the tower efficiency and also the thermal capacity of the gas turbine the electric power of the updraft power plant can consequently be calculated according to the following relationship:

P_{updraft}=Q·η

The change of the overall efficiency, as shown in FIG. 4, can then easily be calculated as an addition of the outputs of gas turbine and updraft power plant.

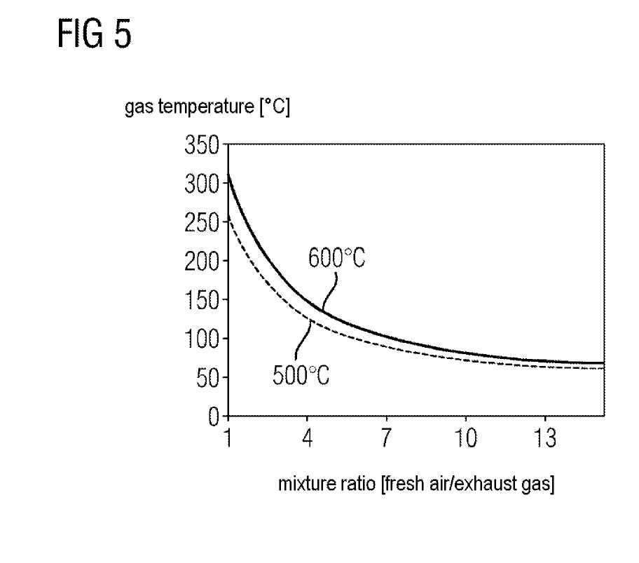

FIG. 5 diagrammatically shows the change of the overall temperature of a mixture of exhaust gas and fresh air corresponding to different mixture ratios. In this case, the change of the overall temperature for two different exhaust gas temperatures is shown. The dashed line shows a variable overall temperature in the case of an exhaust gas temperature of 500° C., the continuous line shows a change of the overall temperature for an exhaust gas temperature of 600° C. By means of the depicted characteristic curves, it can be estimated which temperature level the mixture of exhaust gas with fresh air has upon entry into the tower 12. The temperature level which is required for a concrete embodiment of the tower 12 can correspond to the maximum permissible temperature level at the tower 12, for example, and can be read off directly from FIG. 5.

Further embodiments are gathered from the dependent claims.

1. A power plant comprising
at least one gas turbine and also at least one tower, provided with a power generating unit, for generating electric power via an air-dynamic updraft in the tower,
wherein the gas turbine is fluidically coupled to the tower in such a way that during operation at least some of the exhaust gas of the gas turbine can flow through the tower,
wherein the gas turbine is fluidically coupled to the tower at least partially via a flow duct, wherein the flow duct has a flow section via which fresh air can be added to the exhaust gas so that it mixes with the exhaust gas before and/or while the mixture is fed to the tower.

2. The power plant as claimed in claim 1, wherein the flow duct has a closable branch duct by which the exhaust gas can be fed to a flow path which does not open into the tower but opens into the free environment.

3. The power plant as claimed in claim 1, wherein the flow duct comprises a shut-off device which fluidically closes off the flow duct, in such a way that no exhaust gas can be fed to the tower.

4. The power plant as claimed in claim 3, wherein the flow section is arranged at the end of the flow duct.

5. The power plant as claimed in claim 1, wherein the flow duct is fluidically coupled to a thermal heat accumulator in such a way that the exhaust gas is in thermal contact with the heat accumulator before it is fed to the tower.

6. The power plant as claimed in claim 5, wherein the thermal heat accumulator is arranged beneath the tower on its base, in such a way that thermal heat can be released by the heat accumulator directly to the environment of the base over a prespecified surface.

7. The power plant as claimed in claim 6, wherein the prespecified surface covers at least 30%, of the projection of the inlet opening of the tower which is oriented perpendicularly to the ground.

8. The power plant as claimed in claim 5, wherein the heat accumulator is suitable for storing thermal heat at a temperature level of at least 300° C.

9. The power plant as claimed in claim 5, wherein the heat accumulator has a large number of outlet openings out of which the exhaust gas can flow out in a free manner, for mixing with fresh air.

10. The power plant as claimed in claim 9, wherein the large number of outlet openings are arranged beneath the tower on its base.

11. The power plant as claimed in claim 10, wherein the power plant does not have a flow generator which applies a flow to the fresh air which is provided for mixing with the exhaust gas.

12. The power plant as claimed in claim 1, wherein the tower has a height level above the ground of at most 200 m.

13. A method for operating a power plant comprising at least one gas turbine and also at least one tower, provided with a power generating unit, for generating electric power via an air-dynamic updraft in the tower, comprising:
during operation of the gas turbine, feeding exhaust gas is fed to the tower in such a way that at least some of the exhaust gas flows through the tower and electric power can be generated via the power generating unit, and
adding fresh air is added to the exhaust gas before it is fed to the tower.

14. The method for operating a power plant as claimed in claim 13, wherein fresh air is added to the exhaust gas in such quantity that the temperature level of the mixture is at most 200° C. when it flows to the tower.

15. The power plant as claimed in claim 3, wherein the flow section is arranged beneath the tower on its base.

16. The power plant as claimed in claim 6, wherein the prespecified surface covers at least 50% of the projection of the inlet opening of the tower which is oriented perpendicularly to the ground.

17. The power plant as claimed in claim 5, wherein the heat accumulator is suitable for storing thermal heat at a temperature level of at least 400° C.

18. The power plant as claimed in claim 1, wherein the tower has a height level above the ground of at most 150 m.

19. The method for operating a power plant as claimed in claim 13, wherein fresh air is added to the exhaust gas in such quantity that the temperature level of the mixture is at most 120° C., when it flows to the tower.
